(19) United States
(12) Patent Application Publication
(10) Pub. No.: US 2025/0085704 A1
(43) Pub. Date: Mar. 13, 2025

(54) FAILURE PROBABILITY EVALUATION APPARATUS

(71) Applicant: Hitachi, Ltd., Chiyoda-ku, Tokyo (JP)

(72) Inventor: Hiroshi SHINTANI, Tokyo (JP)

(73) Assignee: Hitachi, Ltd., Chiyoda-ku, Tokyo (JP)

(21) Appl. No.: 18/657,991

(22) Filed: May 8, 2024

(30) Foreign Application Priority Data
Sep. 13, 2023 (JP) 2023-148400

(51) Int. Cl. G05B 23/02

(52) U.S. Cl. CPC G05B 23/0283

(57) ABSTRACT

Provided is a failure probability evaluation apparatus that can improve identification accuracy of a failure probability function of a component and improve evaluation accuracy of a failure probability of the component. A failure probability evaluation apparatus 100 includes a maintenance history database 11, an operation database 12, and a calculation apparatus 13. The calculation apparatus 13 calculates, using a damage model with operation data as a parameter, a progression of damage to a component after installation of a sensor, learns the progression of the damage to the component after the installation of the sensor and estimates a progression of damage to the component before the installation of the sensor, calculates accumulated damage based on the progression of the damage to the component, and identifies, using the accumulated damage, a failure probability function.

### BACKGROUND OF THE INVENTION

### 1. Field of the Invention

The invention relates to a failure probability evaluation apparatus that targets on a component used in a plurality of machines to evaluate a failure probability of the component for each of the machines.

### 2. Description of Related Art

In order to implement a desired function in a machine for electric power generation, transportation, or other industrial purposes, it is important to grasp a failure risk of each component and perform a maintenance (specifically, repair, replacement, or the like) of each component at an appropriate timing. PTL 1 discloses a failure probability evaluation system that targets on a component used in a plurality of machines to evaluate a failure probability of the component for each of the machines.

The failure probability evaluation system in PTL 1 includes a failure history database that stores failure history data of the component in the plurality of machines, an operation database that stores operation data acquired in time series by a sensor of each of the plurality of machines, and a calculation unit that identifies, using the failure history database and the operation database, a failure probability function of the component, and calculates, using the identified failure probability function, the failure probability of the component for each of the machines.

The calculation unit acquires, from the failure history data of the component, a failure time (specifically, an operation time from an initial stage or a previous failure of the machine to a current failure) or a survival time (an operation time from the initial stage or the previous failure of the machine to the present time) of the component. Accumulated damage to the component is calculated by substituting operation data acquired in a period corresponding to the failure time or the survival time of the component into a damage model with the operation data as a parameter, and the failure probability function with the accumulated damage as an explanatory variable is identified.

In the failure probability evaluation system in PTL 1, it is possible to improve evaluation accuracy of the failure probability of the component by considering a load on the component that is different for each machine by using the accumulated damage to the component obtained from the operation data.

### CITATION LIST

### Patent Literature

PTL 1: JP2019-160128A

### SUMMARY OF THE INVENTION

However, in a machine, a sensor that is not initially installed may be added for a certain reason. In this case, operation data acquired by the added sensor is present after the installation of the sensor, but is absent before the installation of the sensor.

For example, when a failure of a component occurs before the installation of the sensor, and thereafter, the component is maintained and the failure does not occur up to the present time, a time from an initial stage of the machine to a failure time point of the component is obtained as the failure time of the component, and a time from the failure time point of the component to the present time is obtained as the survival time of the component. The operation data acquired by the added sensor does not correspond to the failure time of the component or does not correspond to a part of the survival time of the component. Therefore, the operation data acquired by the added sensor cannot be used. Therefore, there is room for improvement in identification accuracy of the failure probability function.

The invention is made in view of the above-described circumstances, and an object thereof is to provide a failure probability evaluation apparatus that can improve identification accuracy of a failure probability function of a component and improve evaluation accuracy of a failure probability of the component.

In order to implement the above-described object, the invention provides a failure probability evaluation apparatus that targets on a component used in a plurality of machines to evaluate a failure probability of the component for each of the machines, the failure probability evaluation apparatus including: a maintenance history database configured to store maintenance history data of the component in the plurality of machines; an operation database configured to store operation data acquired in time series by a sensor of each of the plurality of machines; and a calculation apparatus configured to identify, using the maintenance history database and the operation database, a failure probability function of the component, and to calculate, using the identified failure probability function, the failure probability of the component for each of the machines, in which the calculation apparatus is configured to calculate, using a damage model with the operation data as a parameter, a progression of damage to the component after installation of the sensor, learn the progression of the damage to the component after the installation of the sensor and estimate a progression of damage to the component before the installation of the sensor, calculate accumulated damage to the component based on at least one of the progression of the damage to the component after the installation of the sensor and the progression of the damage to the component before the installation of the sensor, and identify, using the accumulated damage, the failure probability function.

According to the invention, it is possible to improve identification accuracy of a failure probability function of a component and improve evaluation accuracy of a failure probability of the component.

Problems, configurations, and effects other than those described above will become apparent by the following description.

### BRIEF DESCRIPTION OF THE DRAWINGS

FIG. 1 is a block diagram showing a configuration of a failure probability evaluation apparatus according to an embodiment of the invention.

FIG. 2 shows a specific example of maintenance history data according to the embodiment of the invention.

FIG. 3 is a flowchart showing a procedure of processing of identifying a failure probability function according to the embodiment of the invention.

FIGS. 4A and 4B show a specific example of operation data according to the embodiment of the invention and show a specific example of a progression of damage to a component.

FIG. 5 shows a specific example of a variation in the failure probability function according to the embodiment of the invention.

FIG. 6 shows a specific example of a display form of a failure probability according to the embodiment of the invention.

### DESCRIPTION OF EMBODIMENTS

An embodiment of the invention will be described with reference to the drawings.

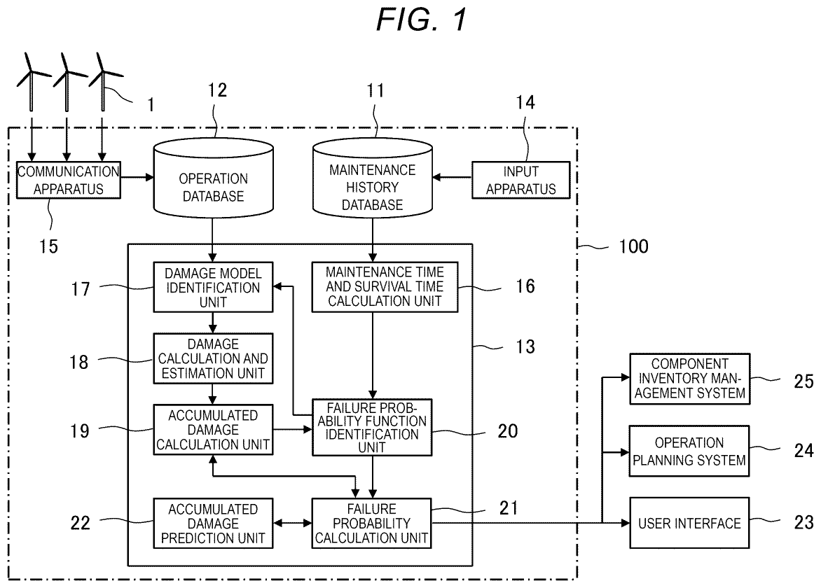

FIG. 1 is a block diagram showing a configuration of a failure probability evaluation apparatus according to the embodiment.

A failure probability evaluation apparatus 100 according to the embodiment targets on a component used in a plurality of machines 1 (wind power generators in the embodiment) to evaluate a failure probability of the component for each machine 1. The failure probability evaluation apparatus 100 includes a maintenance history database 11, an operation database 12, a calculation apparatus 13, an input apparatus 14, and a communication apparatus 15.

The maintenance history database 11 and the operation database 12 each include a storage apparatus such as a hard disk. The calculation apparatus 13 includes a processor that executes processing based on a program, and a memory that temporarily stores an intermediate result or a final result of the processing. The input apparatus 14 includes an input and output interface such as a keyboard and a display. The communication apparatus 1 includes a communication interface connected to a communication network (specifically, a satellite communication network, the Internet, an intranet, or the like) with the plurality of machines 1.

The maintenance history database 11 stores maintenance history data of the component in the plurality of machines 1 received via the input apparatus 14. If each machine 1 has a function of detecting a failure of the component and transmitting information about the failure as the maintenance history data, the maintenance history database 11 may store the maintenance history data of the component in the plurality of machines 1 received by the communication apparatus 15.

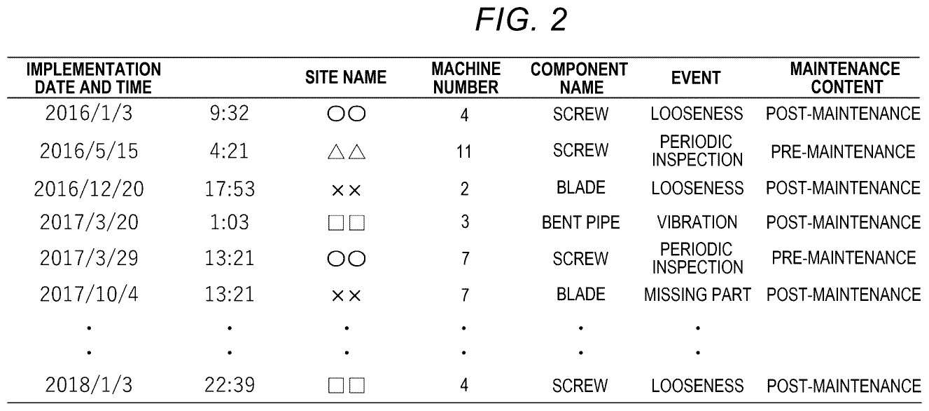

For example, as shown in FIG. 2, the maintenance history data includes, as data items, a maintenance implementation date and time, an installation site (site name) of the machine 1, an identification number (machine number) of the machine 1, a maintenance target component (component name), a maintenance reason (event), and a maintenance content, and is formed by a record that is a combination of such information. A “post-maintenance” in the maintenance content means that a maintenance is performed due to occurrence of a failure or an abnormality of the component, and a “pre-maintenance” in the maintenance content means that a maintenance is performed without occurrence of a failure or an abnormality of the component. The maintenance history data includes not only a record in which the maintenance content is the “post-maintenance” (in other words, failure history data), but also a record in which the maintenance content is the “pre-maintenance”, which can be utilized to improve identification accuracy of a failure probability function to be described later.

The plurality of machines 1 acquire, for example, a temperature, a wind speed, and a power generation amount in time series by a sensor, and transmit such data as operation data. The operation database 12 stores the operation data of the plurality of machines 1 received by the communication apparatus 15.

The operation data may include a measured value of the sensor, or may include a statistical value (for example, a maximum value, a minimum value, an average value, or a standard deviation) for each predetermined time (for example, one day) in order to reduce a data amount. Alternatively, the operation data may include a calculated value calculated based on the measured value of the sensor in order to be easily used as a parameter of a damage model to be described later.

The calculation apparatus 13 has a function of identifying, using the maintenance history database 11 and the operation database 12, the failure probability function of the component. The calculation apparatus 13 includes, as configurations related to the above-described function, a maintenance time and survival time calculation unit 16, a damage model identification unit 17, a damage calculation and estimation unit 18, an accumulated damage calculation unit 19, and a failure probability function identification unit 20. The calculation apparatus 13 has a function of calculating, using the identified failure probability function, the failure probability of the component for each machine 1. The calculation apparatus 13 includes, as configurations related to the above-described function, a failure probability calculation unit 21 and an accumulated damage prediction unit 22.

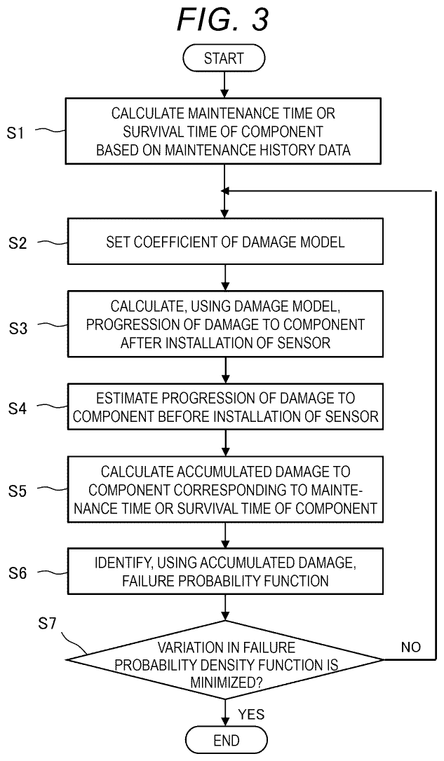

First, the function of identifying the failure probability function will be described with reference to FIG. 3. FIG. 3 is a flowchart showing a procedure of processing of identifying the failure probability function according to the embodiment.

In step S1, the maintenance time and survival time calculation unit 16 sets a target component. Then, a record including the set component name is extracted from the maintenance history data stored in the maintenance history database 11, and the extracted record is classified for each machine 1 (specifically, for each combination of the site name and the machine number). Then, based on the maintenance implementation date and time in the record classified for each machine 1, a post-maintenance time (specifically, an operation time of the machine 1 from an initial stage or a previous maintenance to a current post-maintenance), a pre-maintenance time (specifically, an operation time of the machine 1 from the initial stage or the previous maintenance to a current pre-maintenance), or a survival time (an operation time from the previous maintenance to the present time) of the component is calculated. When there is no record (in other words, maintenance history) for any of the machines 1, an operation time from the initial stage to the present time of the machine 1 is calculated as the survival time of the component. Hereinafter, the post-maintenance time is referred to as a maintenance time, and the survival time is described as including the pre-maintenance time. In step S2, the damage model identification unit 17 sets a coefficient of a damage model d(Xt) related to the set component. The damage model d(Xt) calculates damage per unit time with operation data Xt at a time t as a parameter. Assuming that the operation data Xt at the time t includes values x1, x2, . . . , xm at the time t, the damage model d(Xt) may be expressed as a linear combination of the values x1, x2, . . . , xm, as shown for example in equation (1) below. In this case, the damage model identification unit 17 sets coefficients c1, c2, . . . , cm. The damage model d(Xt) is not limited to equation (1), and may be represented by another equation (specifically, if the operation data includes a temperature, for example, an Arrhenius equation is incorporated).

$$D ( {X}_{t} ) = {c}_{1} {x}_{1} + {c}_{2} {x}_{2} + … + {c}_{{m}^{x} m} \qquad ( 1 )$$

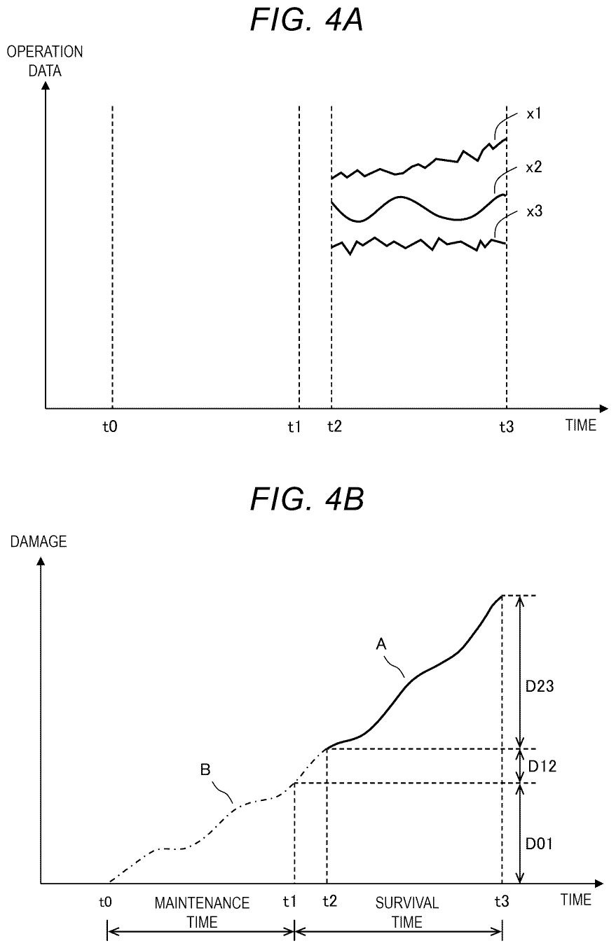

In step S3, the damage calculation and estimation unit 18 substitutes the operation data of each machine 1 stored in the operation database 12 into the damage model described above to calculate a progression of damage to the component of each machine 1. Here, it is assumed that a sensor not initially installed is added to any of the machines 1 for a certain reason. In this case, as shown in FIG. 4A, the values x1, x2, and x3 acquired by the added sensor are present after an installation time point t2 of the sensor but are absent before the installation time point t2. Therefore, as shown in FIG. 4B, a progression A of the damage to the component obtained by substituting the operation data including the values x1, x2, and x3 into the damage model is present after the installation time point t2 of the sensor but is absent before the installation time point t2.

In step S4, the damage calculation and estimation unit 18 learns the progression A of the damage to the component after the installation time point t2 of the sensor by regression analysis, time-series analysis, or the like, and estimates a progression B (see FIG. 4B) of the damage to the component before the installation time point t2 of the sensor.

In step S5, the accumulated damage calculation unit 19 calculates accumulated damage to the component corresponding to the maintenance time or the survival time of the component based on at least one of the progression of the damage to the component after the installation of the sensor and the progression of the damage to the component before the installation of the sensor. This will be specifically described with reference to FIG. 4B.

When the post-maintenance of the component is performed before the installation of the sensor, a time from an initial stage t0 of the machine 1 to a post-maintenance time point t1 of the component is obtained as the maintenance time of the component, and a time from the post-maintenance time point t1 of the component to a present time t3 is obtained as the survival time of the component. The accumulated damage calculation unit 19 calculates accumulated damage D01 from the initial stage t0 of the machine 1 to the post-maintenance time point t1 of the component based on the progression B of the damage to the component before the installation time point t2 of the sensor, and sets the accumulated damage D01 as the accumulated damage corresponding to the maintenance time of the component. The accumulated damage calculation unit 19 calculates accumulated damage D12 from the post-maintenance time point t1 of the component to the installation time point t2 of the sensor based on the progression B of the damage to the component before the installation time point t2 of the sensor, calculates accumulated damage D23 from the installation time point t2 of the sensor to the present time t3 based on the progression A of the damage to the component after the installation time point t2 of the sensor, and sets a sum of the accumulated damage D12 and the accumulated damage D23 as the accumulated damage corresponding to the survival time of the component.

In step S6, the failure probability function identification unit 20 identifies, using the accumulated damage corresponding to the maintenance time of the component and the accumulated damage corresponding to the survival time of the component by a known maximum likelihood estimation method or a known Bayesian estimation method, a failure probability function F(D) with accumulated damage D as a parameter. In the maximum likelihood estimation method, a parameter of the failure probability function is searched for to maximize a log-likelihood sum L defined by the following equation (2). In the equation, f is a failure probability density function by obtained differentiating the failure probability function F(D). A first term on a right side of the equation represents a likelihood of the accumulated damage corresponding to the maintenance time of the component, and a second term represents a likelihood of the accumulated damage corresponding to the survival time of the component.

$$L = \sum log ( f ) + \sum log ( \int f dY ) \qquad ( 2 )$$

In step S7, the failure probability function identification unit 20 determines whether a variation in the failure probability density function f is equal to or less than a predetermined value and thus determines whether the variation in the failure probability density function f is minimized. When the variation in the failure probability density function f is not minimized, the processing returns to step S2. That is, the failure probability function identification unit 20 outputs, to the damage model identification unit 17, a command to change the coefficient of the damage model d(Xt). The damage model identification unit 17 changes the coefficient of the damage model d(Xt) according to the command.

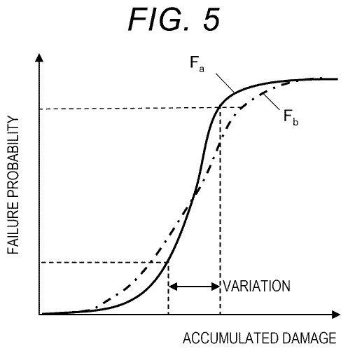

Thereafter, the above-described steps S3 to S6 are performed, and the processing proceeds to step S7. In step S7, the failure probability function identification unit 20 determines whether the variation in the failure probability density function f is equal to or less than the predetermined value and thus determines whether the variation in the failure probability density function f is minimized. This is because the fact that the variation in the failure probability density function f is large (as shown in FIG. 5, a variation in the failure probability function is large) means that there is a width in a failure occurrence prediction interval, and it is necessary to reduce the variation in order to extremely reduce the width in the prediction interval and accurately estimate a next failure occurrence date and time. The variation in the failure probability function can be evaluated by a variation coefficient (a ratio of a standard deviation to an average value of the failure probability function) (see PTL 1). Further, even when the variation in the failure probability density function f is equal to or larger than the predetermined value, it is determined whether a change rate of the variation is equal to or less than predetermined value to determine whether the variation in the failure probability density function f is minimized. When the variation in the failure probability density function f is minimized, identification (coefficient setting) of the damage model d(Xt) by the damage model identification unit 17 and identification of the failure probability function F(D) by the failure probability function identification unit 20 are completed.

In the embodiment, when the damage model d(Xt) is defined, the accumulated damage (corresponding to the accumulated damage D01 and the accumulated damage D12 in FIG. 4B) estimated by the damage calculation and estimation unit 18 through extrapolation changes accordingly. In general, estimation accuracy of extrapolation is lower than that of interpolation, but in the invention, the failure probability function is identified using an extrapolation result, the variation in the failure probability density function f is reduced to approach an accumulated damage model based on a true mechanism that causes an object to fail, and thus a correction function to the extrapolation result is activated, thereby ensuring estimation accuracy.

Next, a function of calculating, using the identified failure probability function F(D), the failure probability of the component for each machine 1 will be described in detail.

The failure probability calculation unit 21 sets a target machine 1 or a target component. When a current failure probability is calculated, a command is output to the accumulated damage calculation unit 19. The accumulated damage calculation unit 19 calculates accumulated damage Da up to the present time in relation to the set machine 1 or the set component according to the above-described command. Specifically, when there is no maintenance history of the component, the accumulated damage Da from the initial stage to the present time of the machine 1 is calculated, and when there is a maintenance history of the component, the accumulated damage Da from a previous maintenance to the present time is calculated. The failure probability calculation unit 21 calculates a current failure probability Pa by substituting the accumulated damage Da up to the present time calculated by the accumulated damage calculation unit 19 into the failure probability function F(D) identified by the failure probability function identification unit 20.

The failure probability calculation unit 21 outputs a command to the accumulated damage calculation unit 19 and the accumulated damage prediction unit 22 when calculating a future (for example, after a period Δt set by a user elapses) failure probability. The accumulated damage calculation unit 19 calculates the accumulated damage Da up to the present time in relation to the set machine 1 or the set component according to the above-described command. The accumulated damage prediction unit 22 predicts accumulated damage Db in the period Δt in relation to the set machine 1 or the set component according to the above-described command. Specifically, for example, the operation data stored in the operation database 12 is learned by regression analysis or time-series analysis, and the operation data in the period Δt is predicted. Then, the progression of the damage to the component in the period Δt is predicted by substituting the operation data in the period Δt into the damage model identified by the damage model identification unit 17. Then, the accumulated damage Db in the period Δt is predicted based on the progression of the damage to the component in the period Δt. The failure probability calculation unit 21 calculates, using the failure probability function F(D) identified by the failure probability function identification unit 20, the accumulated damage Da up to the present time calculated by the accumulated damage calculation unit 19, and the accumulated damage Db in the period Δt predicted by the accumulated damage prediction unit 22, a future failure probability Pb (see the following equation (3)).

$${P}_{b} = ( F ( {D}_{a} + {D}_{b} ) - F ( {D}_{a} ) ) / ( 1 - F ( {D}_{a} ) ) \qquad ( 3 )$$

As described above, the failure probability evaluation apparatus 100 according to the embodiment can identify, using the operation data acquired by the sensor added to the machine 1, the failure probability function of the component. Therefore, the identification accuracy of the failure probability function of the component can be improved, and the evaluation accuracy of the failure probability of the component can be improved.

The failure probability evaluation apparatus 100 of the embodiment outputs data including the failure probability of the component calculated by the calculation apparatus 13 to, for example, a user interface 23, an operation planning system 24, and a component inventory management system 25. The user interface 23 is owned by, for example, an owner, an operation company, or an insurance company of the machine 1.

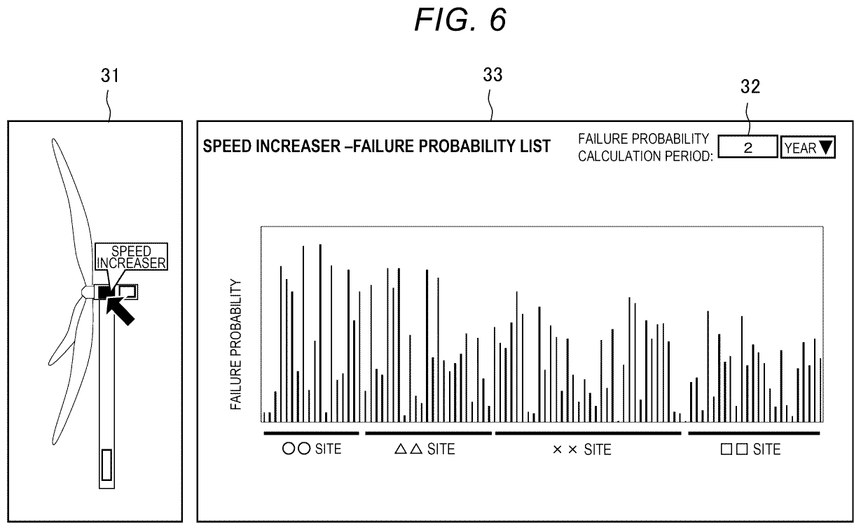

The user interface 23 is, for example, a mobile terminal, and operates in cooperation with the calculation apparatus 13. The user interface 23 displays, for example, a screen shown in FIG. 6. This screen includes a component setting unit 31, a period setting unit 32, and a failure probability display unit 33. The component setting unit 31 schematically shows a configuration of the machine 1 and allows the user to set a target component (for example, a speed increaser). The period setting unit 32 allows the user to set the period Δt from the present time. The failure probability display unit 33 displays the failure probability after a lapse of the period Δt set by the period setting unit 32 related to the component set by the component setting unit 31.

The operation planning system 24 can change an operation plan of the machine 1 according to the failure probability of the component. For example, if the failure probability of the component at the time of a next periodic inspection is higher than expected, the machine 1 is actively stopped or an output of the machine 1 is reduced in order to prolong a service life of the component. When changing the operation plan, the operation planning system 24 outputs information thereof to the failure probability evaluation apparatus 100. The accumulated damage prediction unit 22 of the calculation apparatus 13 changes prediction of the accumulated damage to the component based on the above-described information. Accordingly, the failure probability calculation unit 21 of the calculation apparatus 13 changes and outputs the future failure probability.

In the above embodiment, a case where the failure probability evaluation apparatus 100 includes one calculation apparatus 13 is described as an example, but the invention is not limited thereto, and a plurality of calculation apparatuses may be provided. That is, the maintenance time and survival time calculation unit 16, the damage model identification unit 17, the damage calculation and estimation unit 18, the accumulated damage calculation unit 19, the failure probability function identification unit 20, the failure probability calculation unit 21, and the accumulated damage prediction unit 22 may be implemented by a plurality of calculation apparatuses.

In the above-described embodiment, a case where the machine 1 is a wind power generator is described as an example, but it is needless to say that the invention is not limited thereto.

What is claimed is:

1. A failure probability evaluation apparatus that targets on a component used in a plurality of machines to evaluate a failure probability of the component for each of the machines, the failure probability evaluation apparatus comprising:
a maintenance history database configured to store maintenance history data of the component in the plurality of machines;
an operation database configured to store operation data acquired in time series by a sensor of each of the plurality of machines; and
a calculation apparatus configured to identify, using the maintenance history database and the operation database, a failure probability function of the component, and to calculate, using the identified failure probability function, the failure probability of the component for each of the machines, wherein
the calculation apparatus is configured to
calculate, using a damage model with the operation data as a parameter, a progression of damage to the component after installation of the sensor,
learn the progression of the damage to the component after the installation of the sensor and estimate a progression of damage to the component before the installation of the sensor,
calculate accumulated damage to the component based on at least one of the progression of the damage to the component after the installation of the sensor and the progression of the damage to the component before the installation of the sensor, and
identify, using the accumulated damage, the failure probability function.

2. The failure probability evaluation apparatus according to claim 1, wherein
the calculation apparatus identifies the damage model.

3. The failure probability evaluation apparatus according to claim 2, wherein
the calculation apparatus identifies the damage model such that a variation in a failure probability density function obtained by differentiating the failure probability function is minimized.

4. The failure probability evaluation apparatus according to claim 1, further comprising:
a user interface configured to enable setting of a period from a present time, wherein
the calculation apparatus calculates, using the identified failure probability function, the failure probability of the component after the period elapses, and displays the failure probability on the user interface.

5. The failure probability evaluation apparatus according to claim 4, wherein
the calculation apparatus
calculates the accumulated damage to the component from an initial stage of the machine or a maintenance time point of the component to the present time,
learns the operation data to predict the operation data in the period, and predicts, using the damage model and the operation data in the period, the accumulated damage to the component in the period, and
calculates, using the identified failure probability function, the accumulated damage to the component from the initial stage of the machine or the maintenance time point of the component to the present time, and the accumulated damage to the component in the period, the failure probability of the component after the period elapses.

6. The failure probability evaluation apparatus according to claim 5, wherein
the calculation apparatus changes, based on information from an operation planning system that changes an operation plan of the machine, the prediction of the accumulated damage to the component in the period.
